(19) United States
(12) Patent Application Publication
(10) Pub. No.: US 2016/0102566 A1
(43) Pub. Date: Apr. 14, 2016

(54) POWER TURBINE AIR STRUT

(71) Applicant: PW POWER SYSTEMS, INC., Glastonbury, CT (US)

(72) Inventors: Fabian D. Betancourt, Meriden, CT (US); Fernando K. Grant, South Windsor, CT (US); John J. Korzendorfer, Glastonbury, CT (US)

(21) Appl. No.: 14/512,542

(22) Filed: Oct. 13, 2014

(51) Int. Cl. F01D 9/02; F01D 25/14; F01D 25/12

(52) U.S. Cl. CPC F01D 9/02; F01D 25/12; F01D 25/125; F01D 25/14; F05D 2250/141; F05D 2250/11

(57) ABSTRACT

A power turbine section for a gas turbine engine includes an inlet case along an axis. An inlet duct within the inlet case is along the axis and an air strut is mounted to the inlet case transverse to the axis to extend through the inlet duct, the air strut includes a multiple of passages.

### BACKGROUND

The present disclosure relates to a gas turbine engine and, more particularly, to a power turbine section therefor.

In a gas turbine engine, such as a large frame heavy-duty industrial gas turbine (IGT) engine, a core gas stream generated in a gas generator section is passed through a power turbine section to produce mechanical work. The power turbine includes one or more rows, or stages, of stator vanes and rotor blades that react with the core gas stream.

Interaction of the core gas stream with the power turbine hardware may result in the hardware being subjected to temperatures beyond the design points. Over time, such temperatures may reduce the life of the power turbine at the junction between the gas generator section and the power turbine section.

### SUMMARY

A power turbine section for a gas turbine engine according to one disclosed non-limiting embodiment of the present disclosure includes an inlet duct within an inlet case along an axis and an air strut mounted to the inlet case transverse to the axis to extend through the inlet duct, the air strut including more than one passage.

A further embodiment of the present disclosure includes, wherein the more than one passage includes a first passage and a second passage.

A further embodiment of any of the foregoing embodiments of the present disclosure includes a wall that separates the first passage from the second passage.

A further embodiment of any of the foregoing embodiments of the present disclosure includes, wherein the wall is a longitudinal wall.

A further embodiment of any of the foregoing embodiments of the present disclosure includes, wherein the wall is a lateral wall.

A further embodiment of any of the foregoing embodiments of the present disclosure includes, wherein at least one passage of the more than one passage is circular in cross-section.

A further embodiment of any of the foregoing embodiments of the present disclosure includes, wherein at least one passage of the more than one passage is triangular in cross-section.

A gas turbine engine according to another disclosed non-limiting embodiment of the present disclosure includes a gas generator section and a power turbine section driven by the gas generator section, the power turbine section including an inlet duct through which an air strut extends, the air strut including more than one passage.

A further embodiment of any of the foregoing embodiments of the present disclosure includes, wherein the multiple of passages include a first passage and a second passage.

A further embodiment of any of the foregoing embodiments of the present disclosure includes, wherein the first passage and the second passage are in communication with a compressor section of the gas generator section.

A further embodiment of any of the foregoing embodiments of the present disclosure includes, wherein the first passage is in communication with a first stage of the compressor section and the second passage is in communication with a second stage of the compressor section, the first stage different than the second stage.

A further embodiment of any of the foregoing embodiments of the present disclosure includes a wall that separates the first passage from the second passage.

A further embodiment of any of the foregoing embodiments of the present disclosure includes, wherein the wall is a longitudinal wall.

A further embodiment of any of the foregoing embodiments of the present disclosure includes, wherein the wall is a lateral wall.

A further embodiment of any of the foregoing embodiments of the present disclosure includes, wherein at least one of the multiple of passages are circular in cross-section.

A further embodiment of any of the foregoing embodiments of the present disclosure includes, wherein at least one of the multiple of passages is triangular in cross-section.

A method of communicating a cooling airflow to a power turbine, according to another disclosed non-limiting embodiment of the present disclosure includes communicating a first cooling airflow from a compressor section through an air strut and communicating a second cooling airflow from the compressor section through the air strut.

A further embodiment of any of the foregoing embodiments of the present disclosure includes, wherein the first cooling airflow is at a different pressure than the second cooling airflow.

A further embodiment of any of the foregoing embodiments of the present disclosure includes, wherein the first cooling airflow is at a different temperature than the second cooling airflow.

A further embodiment of any of the foregoing embodiments of the present disclosure includes, wherein the first cooling airflow is communicated to a compartment adjacent to a bearing support.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of an example gas turbine engine architecture;

FIG. 2 is a schematic view of an example gas turbine engine in an industrial gas turbine environment;

FIG. 3 is a perspective view of a power turbine inlet;

FIG. 4 is a schematic sectional view of power turbine inlet;

FIG. 5 is an expanded schematic sectional view of the power turbine inlet;

FIG. 6 is an expanded schematic sectional view of an air strut the power turbine inlet;

FIG. 7 is a perspective view of an inlet to the air strut;

FIG. 8 is an expanded schematic sectional view of the inlet of FIG. 7;

FIG. 9 is a perspective view of an outlet from the air strut;

FIG. 10 is an expanded sectional view of the outlet of FIG. 9;

FIG. 11 is a perspective view of the outlet communication paths to the power turbine; and

FIGS. 12-15 are cross-sections of various flow passage architectures within the air strut.

### DETAILED DESCRIPTION

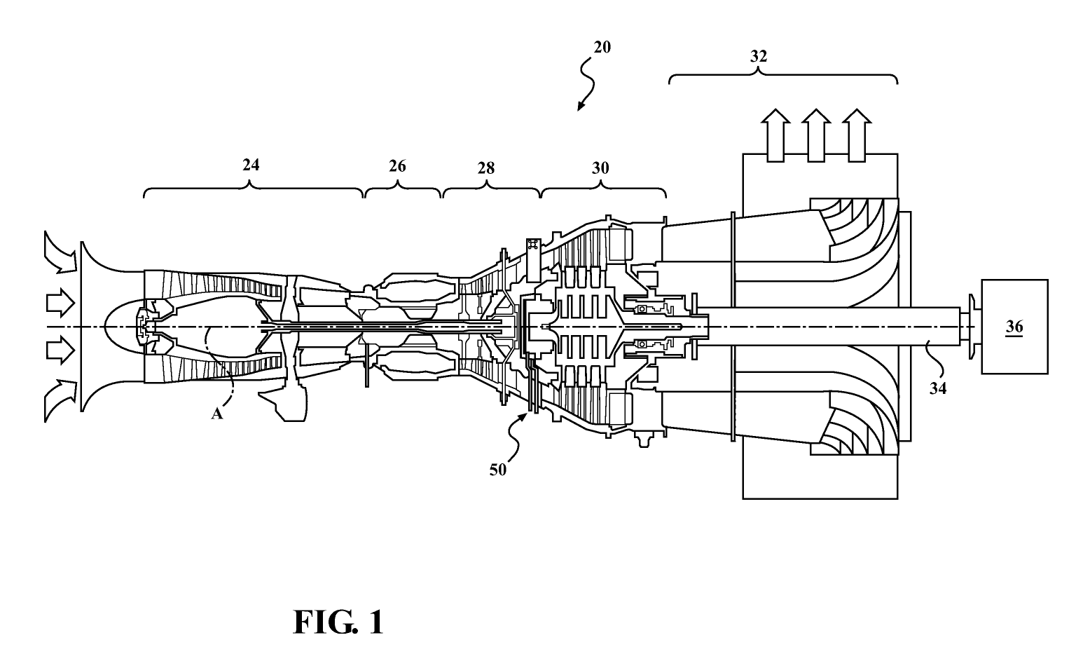

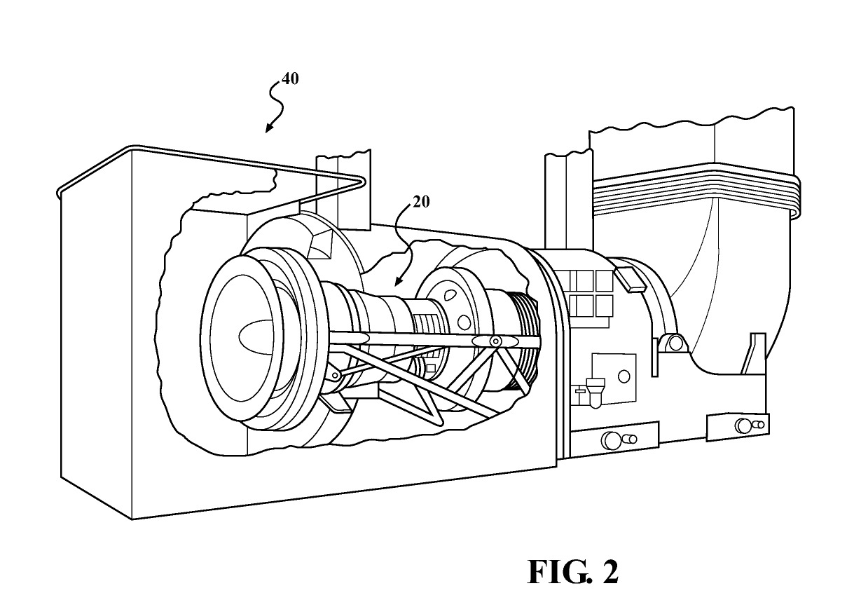

FIG. 1 schematically illustrates a gas turbine engine 20. The gas turbine engine 20 generally includes a compressor section 24, a combustor section 26, a turbine section 28, a power turbine section 30, and an exhaust section 32. The engine 20 may be situated within a ground mounted enclosure 40 (FIG. 2) typical of an industrial gas turbine (IGT). Although depicted as specific engine architecture in the disclosed non-limiting embodiment, it should be understood that the concepts described herein are not limited to only such architecture as the teachings may be applied to other gas turbine architectures.

The compressor section 24, the combustor section 26, and the turbine section 28 are commonly collectively referred to as the gas generator section to drive the power turbine section 30. The power turbine section 30 drives an output shaft 34 to power a generator 36 or other system. The power turbine section 30 generally includes a power turbine inlet 50 (FIG. 3) that communicates the core gas stream from the turbine section 28 of the gas generator into the one or more rows, or stages, of stator vanes and rotor blades. In one disclosed non-limiting embodiment, the power turbine section 30 includes a free turbine with no physical connection between the gas generator section and the power turbine section 30. The generated power is a thereby a result of mass flow capture by the otherwise free power turbine.

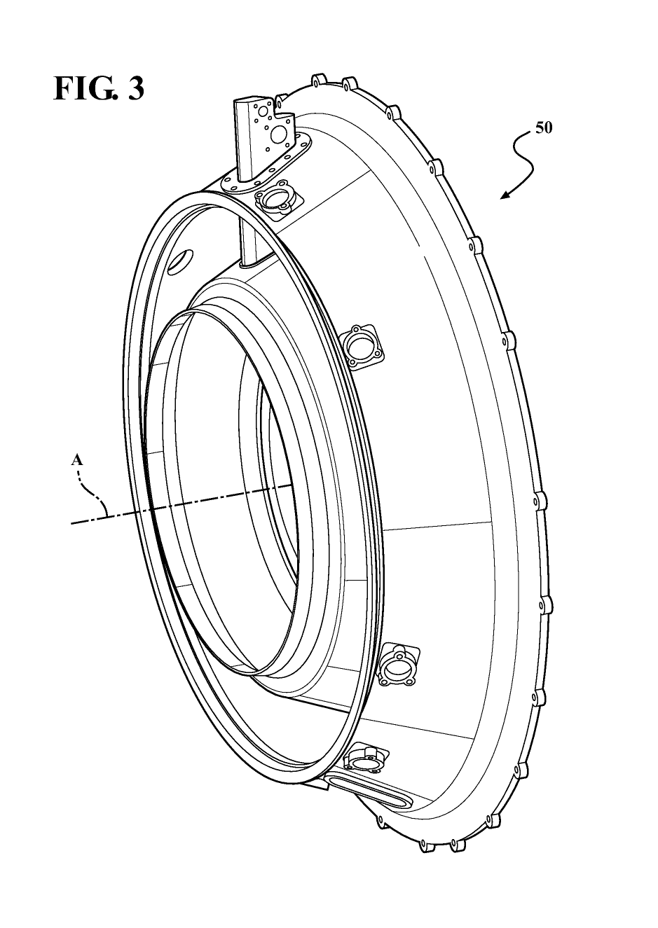

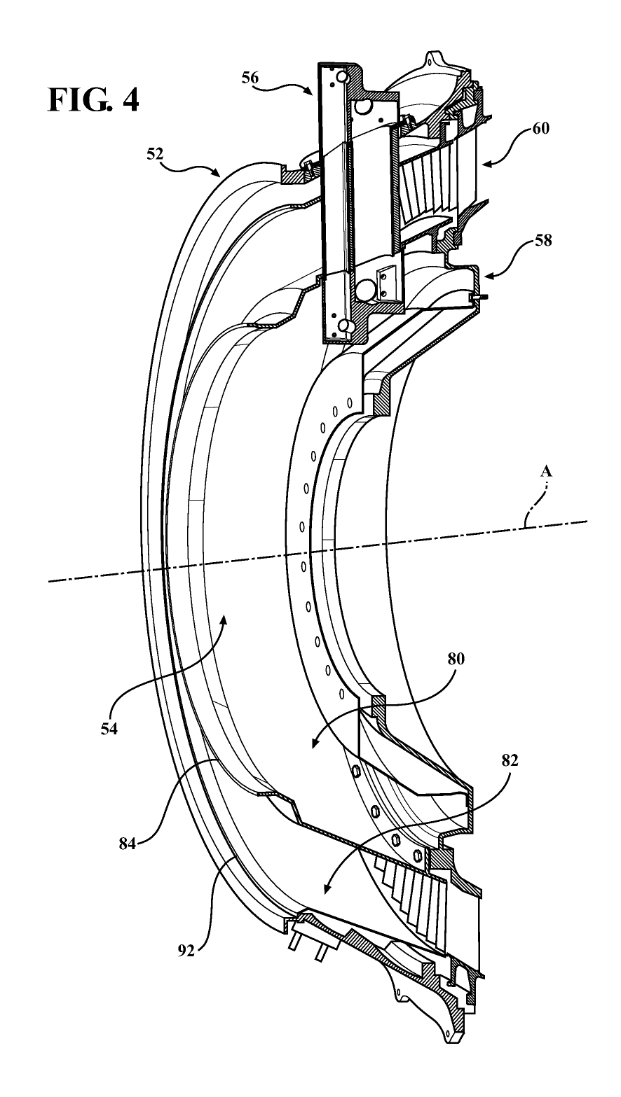

With reference to FIG. 4, the power turbine inlet 50 generally includes an inlet case 52, an inlet duct 54, an air strut 56, a bearing support 58 and a first power turbine vane array 60. The inlet duct 54 is mounted to the inlet case 52 and the bearing support 58 to guide the core gas stream to the first power turbine vane array 60 mounted between the inlet case 52 and the bearing support 58. The engine 20 generally includes a multiple of bearing supports 58 to support the rotational hardware for rotation about an engine central longitudinal axis A. In this disclosed non-limiting embodiment, the bearing support 58, in the power turbine inlet 50 is the #7 bearing support in the engine 20.

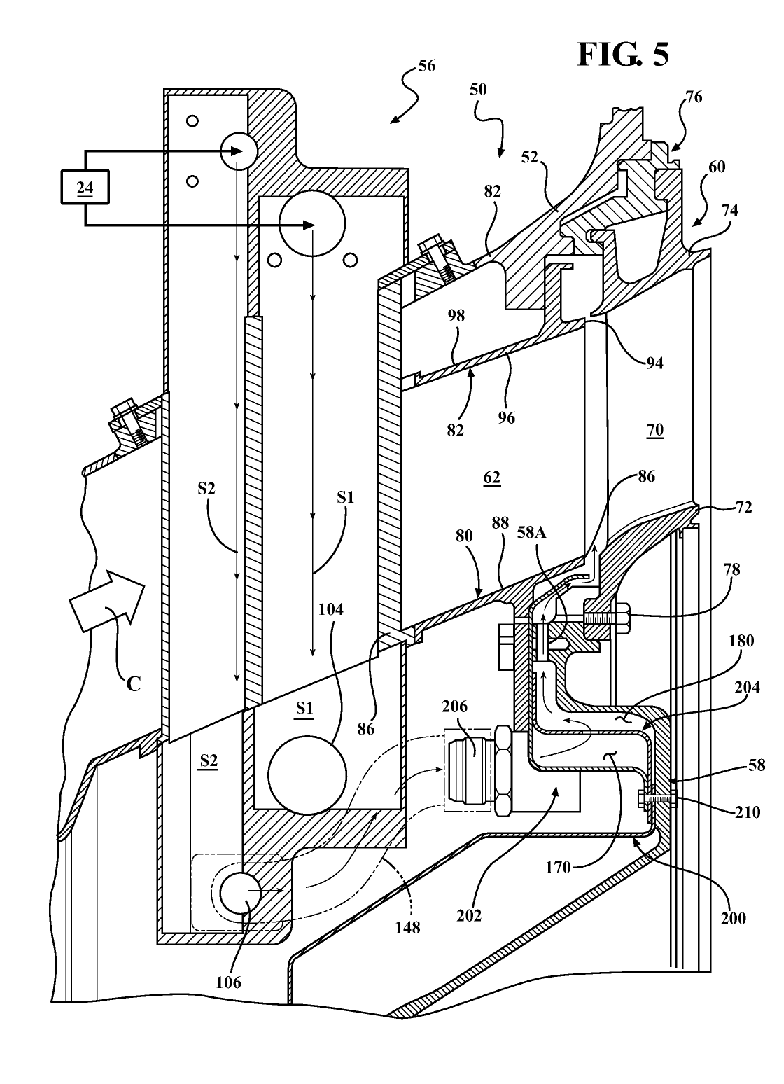

With reference to FIG. 5, the first power turbine vane array 60 generally includes an array of airfoils 70 that extend between a respective inner vane platform 72 and an outer vane platform 74. The outer vane platform 74 may be mounted to the inlet case 52 via a hook and lug arrangement 76 and the inner vane platform 72 may be mounted to the bearing support 58 via fasteners 78 such as bolts. The respective inner vane platform 72 and the outer vane platform 74 at least partially bound a core gas path flow “C” along a core gas path 62. The air strut 56 communicates secondary cooling airflows “S1” and “S2” from, for example, a multiple of stages the compressor section 24 to cool hardware within and around the core gas path 62.

The inlet duct 54 generally includes an annular inner duct wall 80 and an annular outer duct wall 82. The annular inner duct wall 80 includes an upstream edge 84 (shown in FIG. 4), a downstream edge 86, a gas path surface 88, and a non-gas path surface 90. The annular outer wall 82 includes an upstream edge 92 (shown in FIG. 4), a downstream edge 94, a gas path surface 96, and a non-gas path surface 98. The upstream edges 84, 92 are radially inboard of the downstream edges 86, 94 such that the inlet duct 54 generally forms a frustoconical shape (best seen in FIGS. 3 and 4).

The air strut 56 extends through the inlet duct 54 aft of the upstream edges 84, 92 and forward of the downstream edges 86, 94. The downstream edges 86, 94 are upstream of the respective inner vane platform 72 and the outer vane platform 74. The annular inner duct wall 80 and the annular outer duct wall 82 are spaced to generally correspond with the span of the airfoils 70.

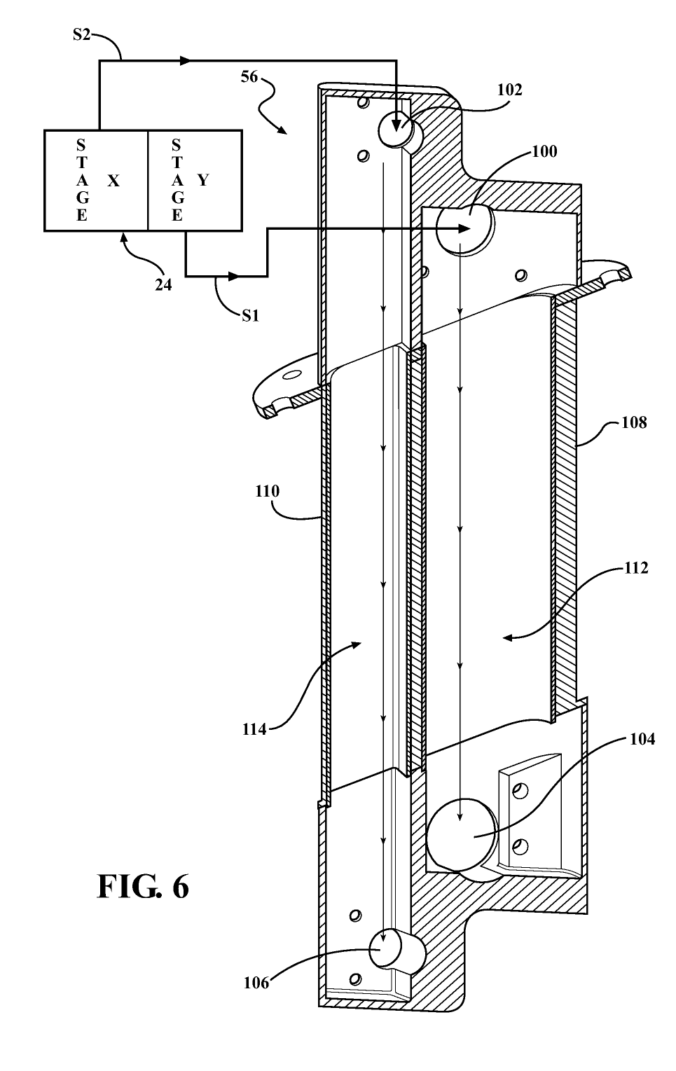

With reference to FIG. 6, the air strut 56 generally includes a first inlet 100, a second inlet 102, a first outlet 104, a second outlet 106 and a respective passage 108, 110 therebetween, to form a respective first passage 112 through the air strut 56 and a second passage 114 through the air strut 56 thereby defining a multiple passage air strut 56. The multiple passage air strut 56 communicates fluid from multiple sources, such as from different stages of the compressor 24, with varied temperatures and pressures into desired locations of the power turbine 30. The passages 112, 114 are sized to balance pressures and temperatures from the selected sources without impact to the upstream sources, i.e., back pressure restricted flow etc.

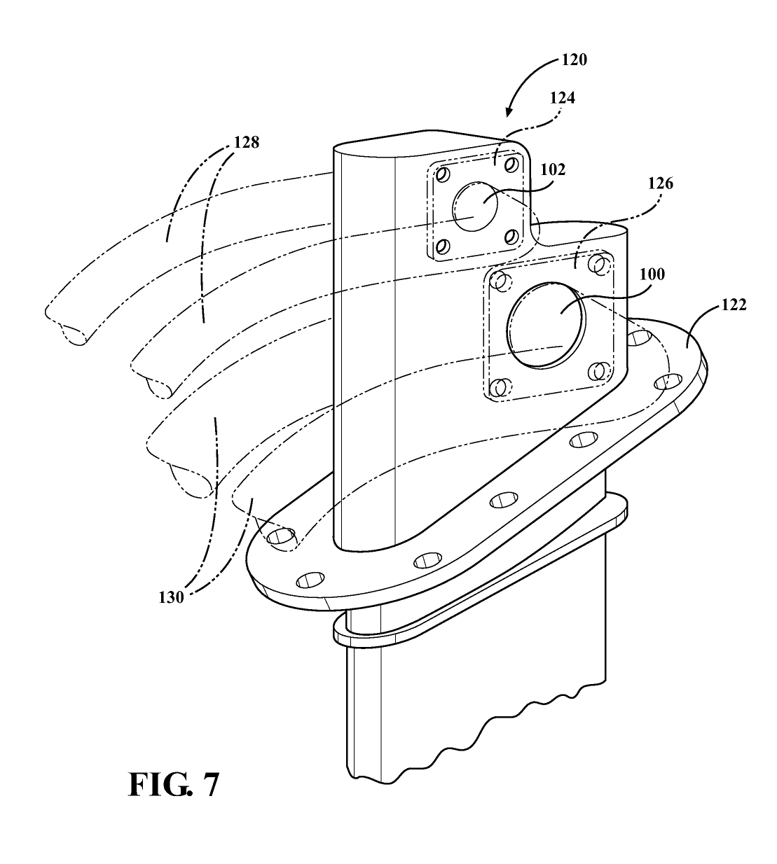

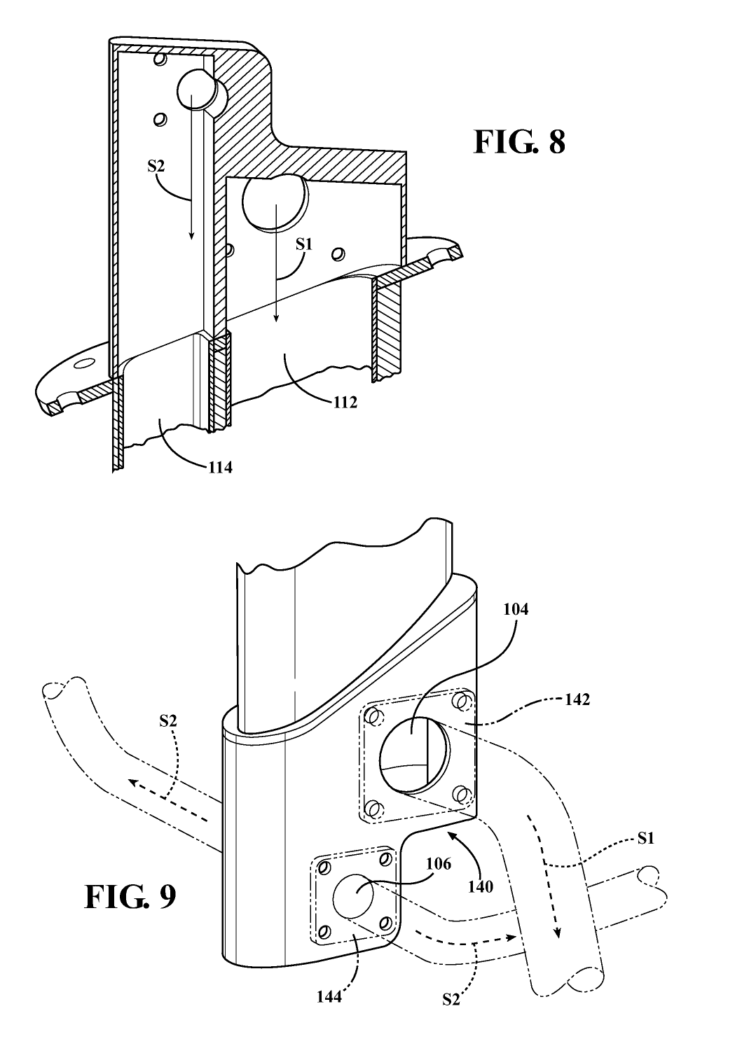

With reference to FIG. 7, the first inlet 100 and the second inlet 102 are located within a stepped area 120 that extends beyond a flange 122 that attaches the air strut 56 to the inlet case 52. The stepped area 120 facilitates attachment of a respective flange 124, 126 of an airflow communication conduit 128, 130 for communication into passages 112, 114. The first inlet 100 communicates airflow “S1” into the first passage 112 and the second inlet 102 communicates airflow “S2” into the passage 114 (FIG. 8).

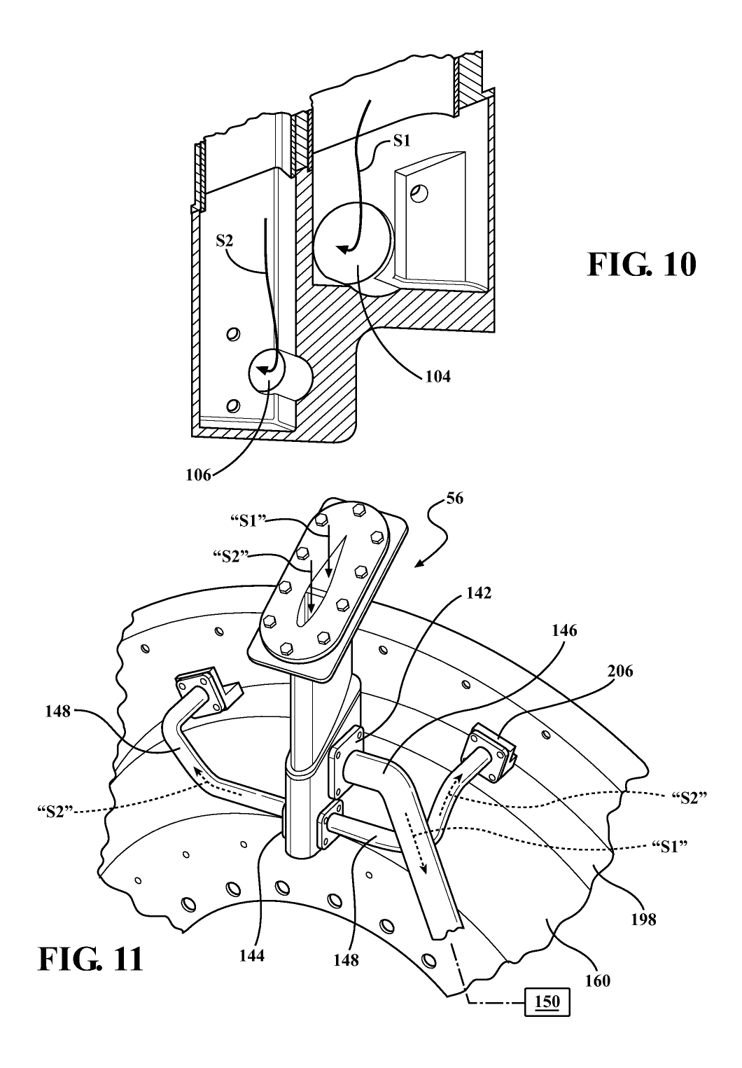

With reference to FIG. 9, the first outlet 104 and the second outlet 106 communicate the separate airflows “S1”, “S2” from passages 112, 114 (FIGS. 8 and 10) to separate locations within the power turbine 30 (FIG. 11). A stepped area 140 facilitates attachment of a respective flange 142, 144 of an airflow communication conduit 128, 130 for communication into passages 112, 114.

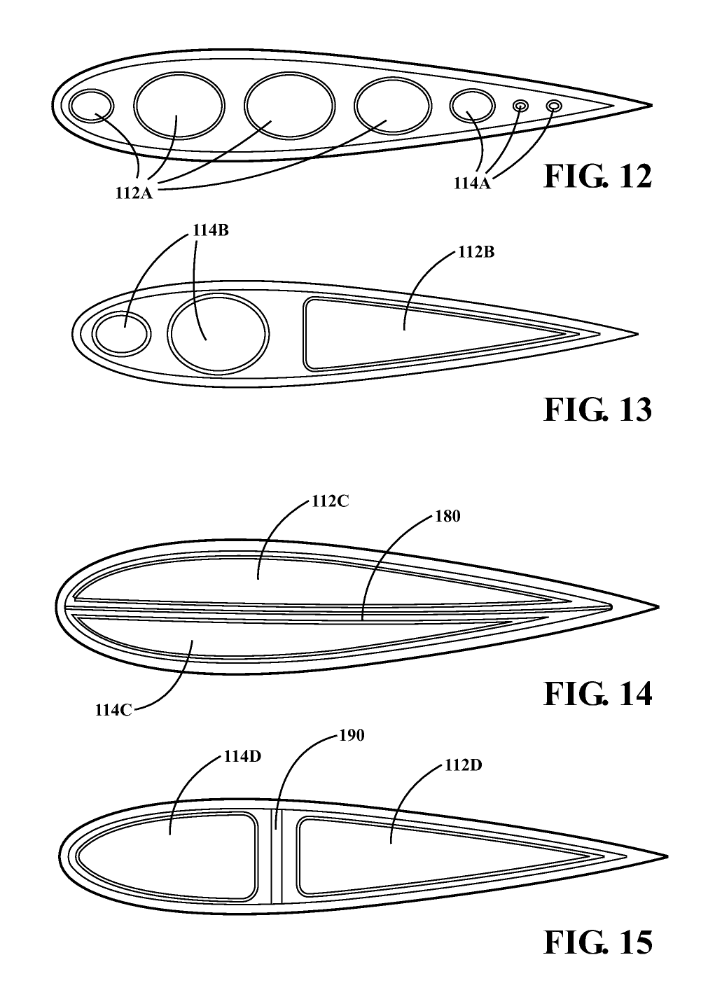

With reference to FIG. 11, the first passage 112, in one disclosed, non-limiting embodiment, routes the airstream of airflow “S1” to compartment 150, while the second passage 114 routes the airstream of airflow “S2” through a heat shield 160, thence to a cavity 170 (FIG. 5) adjacent to the bearing support 58. The first passage 112 and the second passage 114 may be of various cross-sectional areas and combination thereof (FIGS. 12-15).

With reference to FIG. 12, the first passage 112A and the second passage 114A according to one disclosed non-limiting embodiment are defined by a multiple of circular passages for relatively uncomplicated manufacture.

With reference to FIG. 13, the first passage 112B according to another disclosed non-limiting embodiment is a trailing edge cavity that is generally triangular in cross-sectional shape, to conform within the strut 56 outer profile.

With reference to FIG. 14, the first passage 112C and the second passage 114C according to another disclosed non-limiting embodiment are separated by a longitudinal wall 180 therebetween. While the longitudinal wall 180 may be relatively complicated to manufacture, its use to separate the first and second passages 112C, 114C provides substantially all of the interior area of the strut 56 to accommodate a significant quantity of airflow.

With reference to FIG. 15, the first passage 112D and the second passage 114D according to another disclosed non-limiting embodiment are separated by a lateral wall 190 therebetween. The lateral wall 190 stiffens the strut 54 and provides a significant quantity of airflow.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A power turbine section for a gas turbine engine comprising:
an inlet case along an axis;
an inlet duct within said inlet case along said axis; and
an air strut mounted to said inlet case transverse to said axis to extend through said inlet duct, said air strut including more than one passage.

2. The power turbine section as recited in claim 1, wherein said more than one passage includes a first passage and a second passage.

3. The power turbine section as recited in claim 2, further comprising a wall that separates said first passage from said second passage.

4. The power turbine section as recited in claim 3, wherein said wall is a longitudinal wall.

5. The power turbine section as recited in claim 3, wherein said wall is a lateral wall.

6. The power turbine section as recited in claim 1, wherein at least one passage of said more than one passage is circular in cross-section.

7. The power turbine section as recited in claim 1, wherein at least one passage of said more than one passage is triangular in cross-section.

8. A gas turbine engine comprising:
a gas generator section; and
a power turbine section driven by said gas generator section, said power turbine section including an inlet duct through which an air strut extends, said air strut including more than one passage.

9. The gas turbine engine as recited in claim 8, wherein said multiple of passages include a first passage and a second passage.

10. The gas turbine engine as recited in claim 9, wherein said first passage and said second passage are in communication with a compressor section of said gas generator section.

11. The gas turbine engine as recited in claim 10, wherein said first passage is in communication with a first stage of said compressor section and said second passage is in communication with a second stage of said compressor section, said first stage different than said second stage.

12. The gas turbine engine as recited in claim 10, further comprising a wall that separates said first passage from said second passage.

13. The gas turbine engine as recited in claim 12, wherein said wall is a longitudinal wall.

14. The gas turbine engine as recited in claim 12, wherein said wall is a lateral wall.

15. The gas turbine engine as recited in claim 10, wherein at least one of said multiple of passages are circular in cross-section.

16. The gas turbine engine as recited in claim 10, wherein at least one of said multiple of passages is triangular in cross-section.

17. A method of communicating a cooling airflow to a power turbine, comprising:
communicating a first cooling airflow from a compressor section through an air strut; and
communicating a second cooling airflow from the compressor section through the air strut.

18. The method as recited in claim 17, wherein the first cooling airflow is at a different pressure than the second cooling airflow.

19. The method as recited in claim 17, wherein the first cooling airflow is at a different temperature than the second cooling airflow.

20. The method as recited in claim 17, wherein the first cooling airflow is communicated to a compartment adjacent to a bearing support.
